(19) United States
(12) Patent Application Publication
(10) Pub. No.: US 2010/0070921 A1
(43) Pub. Date: Mar. 18, 2010

(54) DICTIONARY CATEGORIES

(75) Inventors: John Rieman, Helsinki (FI); Minna Hekanaho, Oulu (FI); Minna Koutonen, Oulu (FI); Tero Rantonen, Oulu (FI); John Hard, Malmo (SE)

Correspondence Address: Perman & Green, LLP, 99 Hawley Lane, Stratford, CT, 06614, US

(73) Assignee: NOKIA CORPORATION, Espoo (FI)

(21) Appl. No.: 12/565,293

(22) Filed: Sep. 23, 2009

Related U.S. Application Data
(63) Continuation-in-part of application No. 11/693,120, filed on Mar. 29, 2007.

(51) Int. Cl. G06F 3/048; H04W 4/12

(52) U.S. Cl. 715/811; 455/466

(57) ABSTRACT

A method for a portable apparatus including enabling the portable apparatus for character input, comparing the inputted characters with words in a list and prioritizing and listing matches of the comparison in a priority list depending on current context. Further, displaying the priority list, enabling selection from the displayed priority list and enabling updating of the list depending on current context. A corresponding application, apparatus, system, user interface and computer program is also disclosed.

This application is a continuation in part of co-pending U.S. application Ser. No. 11/693,120, filed 29 Mar. 2007, which is incorporated by reference herein in its entirety.

### FIELD

The disclosed embodiments relate to methods for automatic management of categories related to a predictive text dictionary in a portable apparatus, a rendering application, a portable apparatus comprising a display and means for navigating, and a computer-readable medium having computer-executable components.

### BACKGROUND

Communicating via text message services such as short message service (SMS), e-mail, instant messaging, etc., is very popular and plays an increasingly important role in our life.

One popular way of communicating these text messages is by using some kind of handheld communication device such as a mobile phone, a PDA, a palmtop computer, etc. However, entering text messages into these handheld communication devices is often a cumbersome work. While some computing and communication devices, such as personal computers, palmtop computers, and some mobile phones have been equipped with a full QWERTY keyboard for alphanumeric text entry, many other computing and communication apparatuses, such as mobile phones, PDAs, and PDTs, are equipped with a limited or no keyboard. Entering text into computing and communication apparatuses with a limited or no keyboard can be done in several ways. If the apparatus have no keyboard or keys the text can be entered by either writing the text on a special surface, e.g. the screen of the apparatus, with a stylus, or by tapping on a virtual keyboard displayed on the apparatuses screen. Text entering using a keyboard with a limited number of keys, such as a telephone keypad is often done by pressing a key a varying number of times, generally within a limited period of time, to input a specific letter. This technique is known as multi-tap. However, entering text with multi-tap or with a stylus is quite cumbersome for the user, especially if large quantities of text are going to be entered. Therefore, a number of text entering systems have been developed to facilitate and to speed-up the text entering. These systems, often referred to as single-tap system with predictive text technologies, uses predictive letter patterns to allow the user to enter text by press the keys as few times as possible.

The predictive text system uses a predictive text dictionary to “intelligently guess” which character(s) or word(s) the user is about to enter. The predictive text dictionary essentially contains a list of character strings, words, acronyms, abbreviations, etc. that is used to predict which word that is being entered by the user. When entering text using multi-tap or single-tap there may be several words that match a given keystroke(character)sequence. The predictive text system may then select the best match(es), i.e. making a priority list of matching words, based on information about word frequency in the used language or word frequency in the users idiolect.

The memory size needed for a generic predictive text dictionary is quite large. A large predictive text dictionary can be disadvantages as a large number of words, of which many may not be relevant to or used by a user, may result in many suggestions to the user upon entering a number of characters. Too many suggestions may lead to frustration and slows down the input process considerably. This has lead many manufacturers of handheld communication devices to only equip the devices with a pared-down predictive text dictionary. However, this is not an optimal solution since a pared-down predictive text dictionary may not suit every user. To alleviate this problem some manufacturers have added a feature making it possible to tailor the predictive text dictionary by adding or removing words from it. The process of tailoring ones dictionary is often a slow and time-consuming work. Another drawback is that when the user changes his or hers handheld communication device the tailored predictive text dictionary is not transferable and the whole tailoring process must restart on the dictionary in the new device.

The US-patent US2005/0283725 suggest that the predictive text dictionary should be populated based on user determined preferences such as words relevant to the interests, needs, location, etc. of the user. In this way irrelevant and seldom used words will not be included in the predictive text dictionary thus saving valuable memory space. The patent suggest a user interface where the user can select categories of interests e.g. sports, finance, computer, etc, containing words which then populates the predictive text dictionary in the handheld device. A database, which can reside in the device or on an external server, maintains the users words related to his or hers interests and can easily be downloaded to a new device, thus eliminating the need to re-tailor the predictive text dictionary. The predictive text dictionary in the handheld device is then updated on specific occasions e.g. when turned on/off, once each day, etc.

The improvements shown in US-patent US2005/0283725 may reduce some of the problems of using a predictive text dictionary but the approach does not take into account a crucial aspect namely the sudden change in physical and social context of the user.

### SUMMARY

In view of the above, it would be advantageous to solve or at least reduce the problems discussed above. In particular, it would be advantageous to provide a user a friendly and efficient ways of tailor and populate the predictive text system in a users handheld communication device.

According to a first aspect of the disclosed embodiments, there is provided a method for a portable apparatus, comprising enabling said portable apparatus for text input, comparing inputted text with text in an user configured predictive text dictionary, prioritizing matches in said comparison and listing said matches based on said prioritizing in a priority list, displaying of said priority list, enabling selection from said displayed priority list, and enabling updating of said user configured predictive text dictionary based on matches in said comparison.

The method may comprise updating of said user configured predictive text dictionary based on any of the group: analysis of said inputted text, selected words in said displayed priority list, and user configured preferences.

The method may comprise a user-configured preferences comprised of a set of words belonging to a category.

The method may comprise communicating by wire or wirelessly with an external server via a network for acquiring said dictionary.

The method may comprise storing said dictionaries via said network and retrieving said dictionaries from said external server.

According to a second aspect of the disclosed embodiments, there is provided a rendering application for a portable apparatus comprising a display and navigation means, said application arranged to cause enabling of said portable apparatus for text input, comparing inputted text with text in an user configured predictive text dictionary, prioritizing matches in said comparison and listing said matches based on said prioritizing in a priority list, displaying of said priority list, enabling selection from said displayed priority list, and enabling updating of said user configured predictive text dictionary based on matches in said comparison.

According to a third aspect of the disclosed embodiments, there is provided an apparatus arranged to receive a user input, wherein said user input comprise of a text input, compare inputted text with text in a user configured predictive text dictionary, a processor arranged to prioritize and list matches of an output of said comparator in a priority list, wherein said display is arranged to, under control of said processor to display said priority list, and wherein said user input selection from said displayed priority list, wherein said processor is arranged to update said user configured predictive text dictionary based matches in said comparison.

According to a fourth aspect of the disclosed embodiments, there is provided a computer-readable medium having computer-executable components comprising instructions for enabling said portable apparatus for text input, comparing inputted text with text in an user configured predictive text dictionary, prioritizing matches in said comparison and listing said matches based on said prioritizing in a priority list, displaying of said priority list, enabling selection from said displayed priority list, and enabling updating of said user configured predictive text dictionary based on matches in said comparison.

According to a fifth aspect of the disclosed embodiments, there is provided a system comprising an apparatus according to the third aspect of the invention, and a dictionary server arranged to provide the associated dictionary for downloading.

The system may comprise a communications network, wherein the dictionary server and the apparatus is in communication via the communications network.

According to a sixth aspect of the disclosed embodiments, there is provided a user interface comprising

a display, and an input receiver, wherein said user interface is arranged to enable said portable apparatus for text input where said inputted characters are compared with words in a an user configured predictive text dictionary and matches of said comparison are listed in a list, and to display said list in said display.

The second, third, fourth, fifth and sixth aspects of the disclosed embodiments may be combined in any way with the features of the first aspect of the disclosed embodiments.

In the above description a renderer should be interpreted as a functional block applicable to any communication device, such as a mobile phone, capable of performing at least one of the following tasks; inputting, prioritizing, displaying, enabling, selecting, and updating.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

Other features and advantages of the disclosed embodiments will appear from the following detailed disclosure, from the attached dependent claims as well as from the drawings.

### BRIEF DESCRIPTION OF THE DRAWINGS

The above, as well as additional features and advantages of the disclosed embodiments, will be better understood through the following illustrative and non-limiting detailed description of preferred embodiments with reference to the appended drawings, where the same reference numerals will be used for similar elements, wherein:

FIG. 1 shows a mobile communication apparatus according to an embodiment;

FIG. 2 shows a flow chart describing a common character input process using a predictive text dictionary; and

FIG. 3 shows a display view of a handheld communication apparatus; and

FIG. 4 shows a flow chart describing a character input process using an updatable predictive text dictionary; and

FIG. 5 illustrates ways of communication between a mobile communication apparatus, a server and another mobile communication apparatus; and

FIG. 6 shows a display view of how categories of interests can be combined; and

FIG. 7 shows a display view of a web application setting preferred categories; and

FIG. 8 shows a display view of a handheld communication apparatus exemplifying setting of preferred categories;

FIG. 9 schematically illustrates a system according to an embodiment;

FIG. 10 illustrates a computer readable medium according to an embodiment; and

FIG. 11 illustrates an example of a user interface of the disclosed embodiments.

### DETAILED DESCRIPTION OF PREFERRED EMBODIMENTS

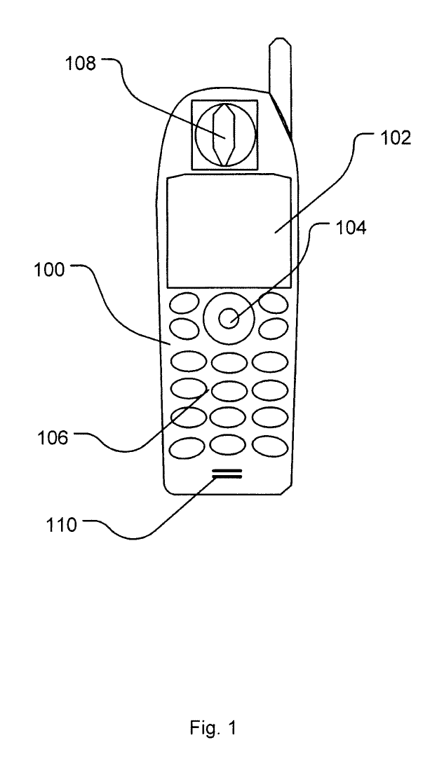

FIG. 1 shows a mobile communication apparatus 100 comprising a display 102 and means 104 for navigating among items (not shown) displayed in a display area 102. The navigation means 104 can be a rotating input, a joystick, a touch pad, but can also be implemented using a touch sensitive display, wherein the displayed items directly can be tapped by a user for selection, or be voice activated via a headset or a built-in microphone.

The mobile communication apparatus can also comprise other elements normally present in such an apparatus, such as a keypad 106, a speaker 108, a microphone 110, a processor (not shown), a memory (not shown), etc.

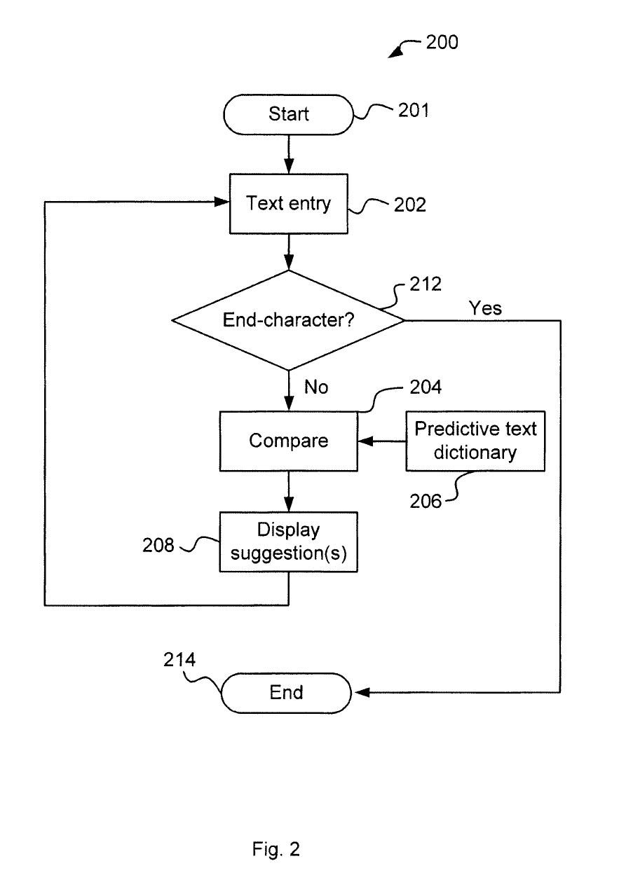

FIG. 2 shows a flow chart illustrating a common process of entering text in a handheld communication device, such as a mobile phone, with a predictive text system 200. The alphanumerical characters can be entered 202 using a stylus, writing or tapping the characters on the screen or on a dedicated area of the apparatus, or by using all or some of the keys on the handheld communication apparatuses full or limited keyboard.

The last entered alphanumerical character is compared 212 with a predetermined and/or user configurable end-character such as a for example a ‘space’ character. If the entered 202 alphanumeric character is an end-character 212 the input of that specific character, group of characters, word, phrase, slang, abbreviation, etc. (hereinafter referred to as a word) is complete, and the text entry ends 214. If the user continues to enter alphanumerical characters after the end-character, i.e. begins to input a new word, the process restarts 201, else the user have entered all the words to complete a message and terminates the input process.

If no end-character is detected 212 the character entry is continued and the alphanumeric character, either by itself or in combination with other previous added characters forming a word or a part of a word, are compared in 204 with characters, words, phrases, abbreviations, slang, etc. stored in a predictive text dictionary 206. If one or several, complete or partial, matches between an entered word(s) 202 and words in the dictionary 206 are detected, they are made available, e.g. displayed on the screen of the handheld communication apparatus as a list of suggestions, to the user 208. If several matches are found they are displayed in the suggestions list. The user is then able to choose any of the available words from the displayed suggestions list using the navigation means 104 mentioned in conjunction with FIG. 1. The character input process is continued 202 regardless of if the user chooses a word from the displayed list or continues to input characters. The input process continuous until an ‘end character’ is detected 212 or the character input is terminated by the user.

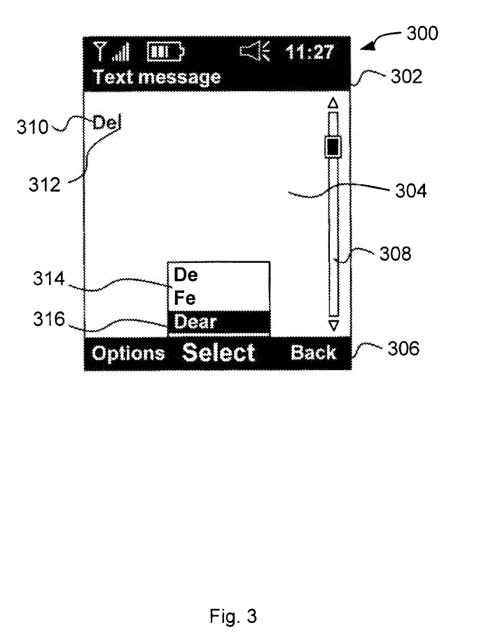

FIG. 3 illustrates an example of a common display view in a handheld communication apparatus 300, running a predictive text system, comprising a general status indication section 302, a softkey bar 306 and a general display area 304. The general status indication section 302 can for example include symbols for battery status, reception quality, speaker on/off, present mode, clock time, etc. The status indication section is not in any way limited to only include these symbols. Thus, other symbols in any shape, form, or color can occur. The softkey bar 306, situated at the bottom of the display view, is operable using the navigation means 104 mentioned in conjunction with FIG. 1. The functions of these softkeys are not limited by the functions indicated in the figure.

The preferred function of the general display area 304, residing between the status indication section 302 at the top and the softkey bar 306 at the bottom, is to display information from running applications in the handheld communication apparatus. In our case the display area 304 also comprise a scroll bar 308, a suggestion list 314, inputted characters 310, and a cursor 312 showing where next character, word, phrase, abbreviation, etc. can be inputted.

FIG. 3 shows an example of how a common predictive text system, such as described in FIG. 2, operates. A user has entered the characters ‘D’ and ‘e’ 310 which together with a cursor 312 is shown at the top of the display views display area 304. The last entered character is ‘e’ which in this case is not an end-character. The two characters ‘D’ and ‘e’ forms the word ‘De’ which is compared against the words and the letter combinations stored in the predictive text dictionary. Several matches are found and they are displayed to the user in a suggestion list 314. The displayed suggestions are ‘De’, ‘Fe’, and ‘Dear’ where ‘De’ is rated the most likely word (highest priority) and therefore displayed first in the list. ‘Fe’ is rated second most likely (priority 2) and ‘Dear’ rated third most likely (priority 3). Since the user in this example wants to enter the word ‘Dear’, the user have to navigated amongst the suggestions down to the suggestion ‘Dear’, indicated by the black cursor bar 316. The user selects ‘Dear’ by operating ‘Select’ in the softmenu and ‘De’ is replaced by ‘Dear’ 318 as shown in the figure. The user can continue to enter characters, for example a ‘s’ to complete the word ‘Dears’ or enter a ‘space’, indicating that the word is complete and a new word is going to be entered, thus restarting the inputting and prediction process as described in conjunction with FIG. 2.

A common predictive text system as the one depicted in FIG. 2 and exemplified in FIG. 3, suffers from the problems discussed in the above section describing the background of the invention.

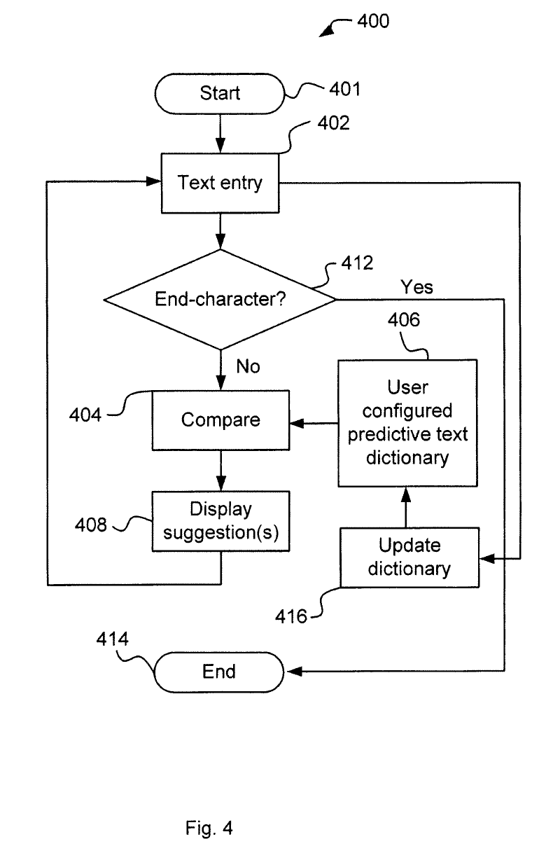

FIG. 4 shows a flow chart illustrating an embodiment comprising a process of entering text in a handheld communication device, such as a mobile phone, with a user configurable predictive text system 400. The alphanumerical characters can be entered 402 using a stylus, writing or tapping the characters on the screen or a dedicated area of the apparatus, or by using all or some of the keys on the handheld communication apparatuses full or limited keyboard.

The last entered alphanumerical character is compared 412 with a predetermined or user configurable end-character such as for example a ‘space’ character. If the entered 402 alphanumeric character is an end-character 412 the input of that specific character, characters, word, phrase, slang, abbreviation, etc. is completed and the text entry is ended 414. If the user continues to enter alphanumerical characters after the end-character, i.e. begins to input a new word, the process restarts 401, else the user have entered all the words to complete a message and terminates the input process.

If no end-character is detected 412 the character entry is continued and the alphanumeric character, either by itself or in combination with other previous added characters forming a word or a part of a word, are compared in 404 with characters, words, phrases, abbreviations, slang, etc. stored in the user configured predictive text dictionary 406.

If one or several, complete or partial, matches between an entered character or word(s) 402 and words in the user configurable predictive text dictionary 406 are detected, they are made available, e.g. displayed on the screen of the handheld communication apparatus as a list of suggestions 408, to the user. Multiple matches are displayed in the suggestions list in a prioritized order with the most likely at the top of the list. Words that are never or seldom used by a user, words that in a specific context is unlikely to be chosen, and words that in a context is deemed inappropriate words can be made to (user configurable) not appear in the suggestion list 408, thus making the list considerably shorter. Optimally the wanted word is always displayed at the top of the suggestion list. The user is then able to choose any of the available words from the displayed suggestions list using the navigation means 104 mentioned in conjunction with FIG. 1. The text input process is continued 402 regardless of if the user chooses a word from the displayed suggestion list 408 or just continues to input new characters 402. The input process continuous until an ‘end character’ is detected 412 or the text entry is terminated by the user.

The user configurable predictive text dictionary 406 generally consists of a large memory consuming generic predictive text dictionary. As discussed above such a dictionary takes up lots of space and contains many words that are irrelevant and never used by the user. One way of reducing the size of the dictionary and to increase the relevance of the words in the predictive text dictionary is to use one or a collection of smaller dictionaries based on user preferred categories containing words and expressions commonly used by the user.

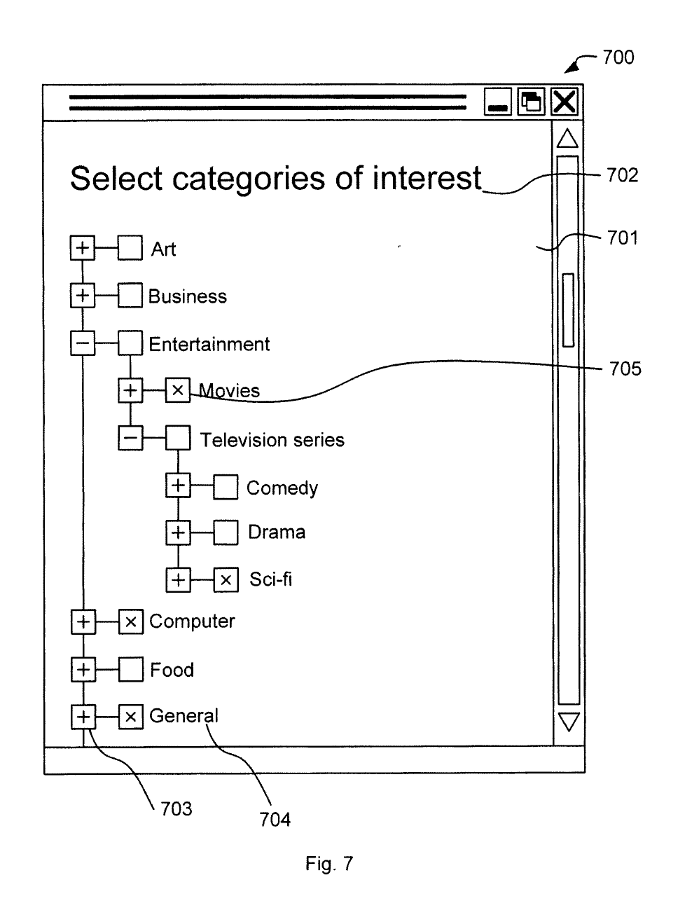

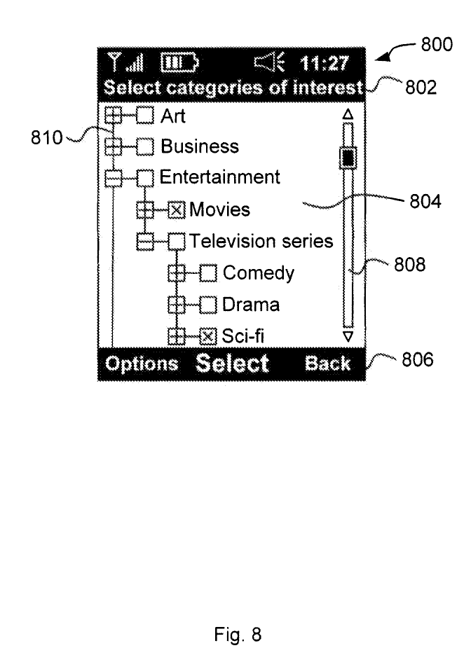

In this case the generic predictive text dictionary have been divided into several smaller dictionaries based on specific categories. Each category comprise a small dictionary covering a specific field of interest such as sports, grandparents, entertainment, commonly used words, medicine, physics, co-worker, computers, etc. The user configures the handheld communication device to include only categories of interest (or often used) in the user configured predictive text dictionary 406, thus reducing the size of the predictive text dictionary and also increasing the word relevance significantly. In this way only words that the user frequently use in his or hers conversations are present in the user configured predictive text dictionary. The configuration and the selection of categories are discussed in more detail in conjunction with FIGS. 7 and 8.

The user configurable predictive text dictionary 406 is adaptive, meaning that the content of the dictionary is subject to continuous updating 416. The update dictionary 416 monitors the user text input and the currently active categories in the user configured predictive text dictionary 406.

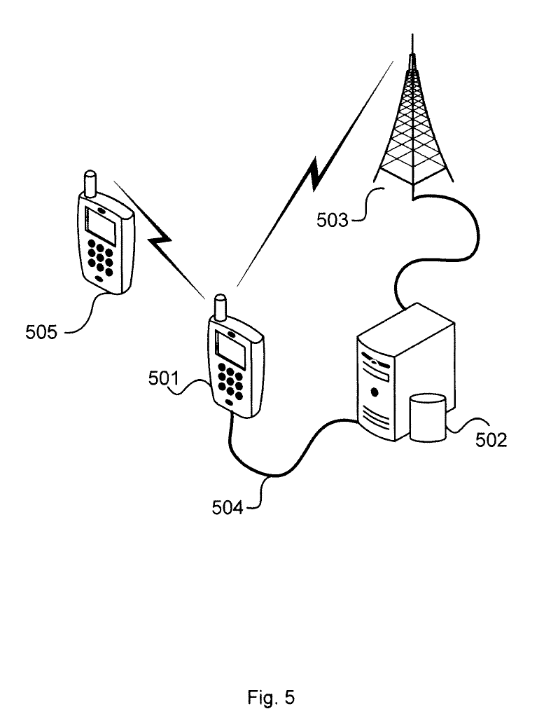

A user constantly changes both physical and social context and with it also his or hers vocabulary. This will affect the words used when entering text messages into the handheld communication device and consequently which categories that needs to be active in the user configurable predictive text dictionary 406. If the update dictionary 416 detects that the user suddenly changes vocabulary and starts using words not active in the current categories in the user configurable predictive text dictionary 406, then the categories needs to be updated or changed. Usable but inactive categories, receding in the handheld mobile communication devices memory, can then automatically be activated by the update dictionary process 416, and unused dictionary can in the same manner be deactivated to save processing time (look-up time in the dictionary) and memory storage. If no suitable categories is currently in the handheld communication device then suitable categories can be downloaded from a database on an external server as described in detail in FIG. 5. Unused categories can in the same manner be sent to the database on the server for storage until they are needed by the user in another context. The update dictionary process can either be managed by the user, be automated, or a combination of both.

FIG. 5 shows the communication between the users handheld communication device 501, another users handheld communication device 505, a wired 504 and a wireless cellular communication network 503 connected to a server with a database 502 for storing the users dictionary categories. Active and frequently used categories are stored within the users communication device while inactive and safety backed-up categories are stored in the database on the server 502. The externally stored categories can either be only accessible to one user (private), to a group of users (members), or to anyone (public).

The user can populate, i.e. add and remove words, to the categories stored in the handheld communication device 501 via an application described in more detail in FIG. 8. Populated categories in the handheld communication device 501 can then be synchronized with the database on the server 502 as a safety precaution or to share it with others. Non-active categories receding in the database on the server 502 can be populated via a web-based application described in more detail in FIG. 7.

A user 501 can also share categories with another user 505 by uploading (or enabling downloading) the categories to the other user by a wireless connection. The other user 505 can also, if allowed, download shared categories from the database on the server 502. A user can also, when docked, communicate, populate, and download/upload categories by a wired connection 504 to the handheld communication device 501.

The external storing of categories as described above will facilitate when changing or buying a new handheld communication device. In this way the user-populated categories can easily be migrated to the new handheld communication device saving lots of time re-populating the new device.

The categories, both in the handheld communication device and on the server, can be configured to be automatically populated by new words. For instance, if a new processor called MegaCalc with 8 processors on a single chip is released by the new company ChipCorp, the word ‘MegaCalc’ and ‘ChipCorp’ are added to the ‘Computer’ category. If the category is currently in use in the handheld device it is updated by the wireless connection 503, and if the category is in the database it can be updated either by wire or a wireless connection to the server 502.

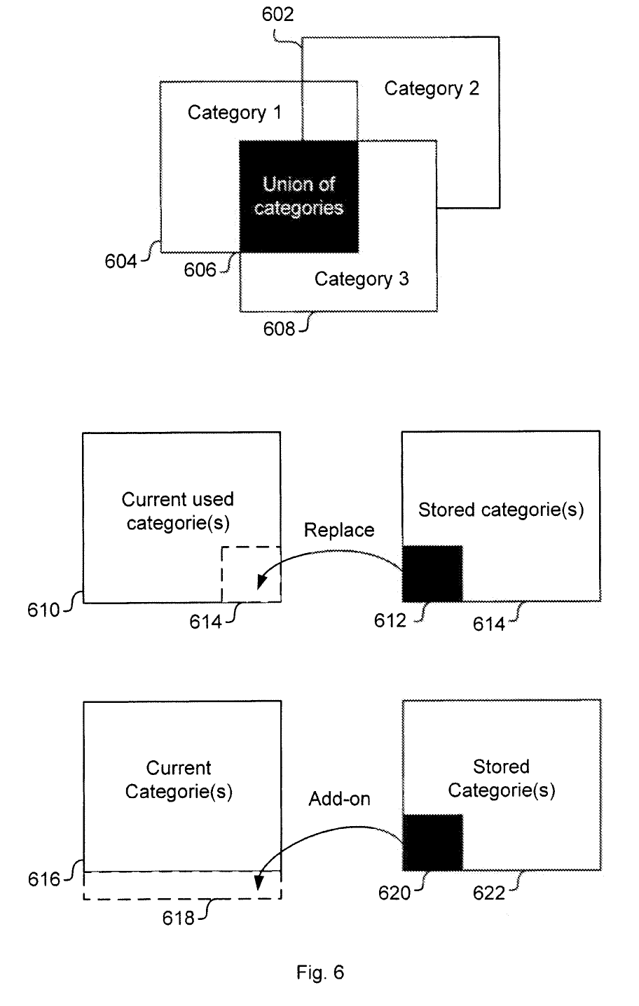

FIG. 6 shows how the active dictionary categories can be used in the predictive text system. The user configured text predictive dictionary can at a given time consist of a single (dictionary) category, a group of categories, or all categories available (more or less equal to a full generic dictionary). The updating of the user configured text predictive dictionary can be done in several different way regardless if it is done internally in the handheld device or over a wired or a wireless connection.

Categories not currently used, receding in the devices memory, can automatically be selected and thereby activated for usage and active, but not currently used, categories can consequently be deactivated. If no suitable dictionary is available in the devices memory, one or more can be downloaded from an external server.

If more than one category needs to be used in a situation then several categories can be activated and used together at the same time. However, in handheld devices with limited storage capabilities it might be impossible to use more than one category at the time. In this case the union of several categories can be used as shown in FIG. 6. In FIG. 6, relevant words from three categories category 1 604, category 2 602, and category 3 608, are combined to form a union category 606. The union category can be tailored to fit any size of memory.

Another way of updating the user configured predictive text dictionary is to replace an obsolete active category 614 (de-selecting the category) and replace it with a stored category (selecting the category) 612. Yet another way is to add (selecting the category) 620 a stored category to already active categories 618. The methods described above can be user-configured to either be executed automatically or manually by the user. The different methods discussed above can be combined in any way possible.

FIG. 7 illustrates a web interface 700 showing the procedure of selecting categories of interests 702. A generic dictionary is divided into several categories of smaller dictionary where each category describes a field of interest. The categories are arranged in a selectable tree structure 703 as shown in the window 701 in FIG. 7. The user selects which categories he or she finds the most interesting and usually converse about with his or hers friends. The user in the example in FIG. 7 are interested in ‘movies’ 705, ‘sci-fi’ television shows, and ‘computers’ and have selected these categories (shown by the x:es). The ‘General’ category 704 is also selected and this category includes the most commonly used words in conversations such as ‘Hi’, ‘to’, ‘of’, ‘bye’, ‘no’, etc.

If the user starts to converse about ‘Food’ he or she could either manually go in and select the category, thus downloading and integrating or replacing the active category(ies), or let the update dictionary detect the change in vocabulary and automatically select the ‘Food’ category. If there is no place for the ‘Food’ dictionary an active category, for instance the ‘Computer’ category, is automatically removed (de-selected).

FIG. 8 show the same selection interface 800 running in a display view 804 of a handheld communication device. The same category tree structure 810 is displayed in the display view 804 and the categories can be selected and de-selected using the devices means for navigation. All the configurations can also be executed from the handheld device.

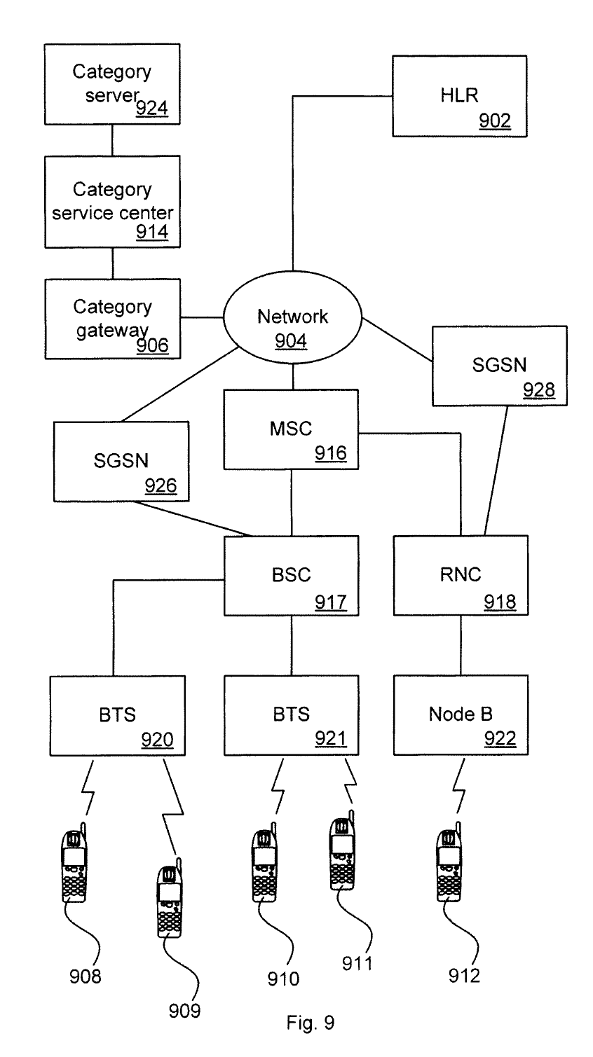

A system architecture for managing a system 900 according to an embodiment is shown in FIG. 9. A Home Location Register (HLR) 902 contains a database (not shown) including relevant subscriber information for provision of telecommunication service. A International Telecommunication Union (ITU) specified network 904 interconnects the individual parts of the system 900. A category gateway 906 is a switching unit routing a requested category to a mobile communication apparatus 908-912. A Category Service Center 914 (DSC) and the category gateway 906 handle and routes the categories between the DSC 914 and the network 904. From the network 904, the categories are routed to the handheld communication devices 908-912 via a Mobile Switching Center (MSC) 916 to a Base Station Controller (BSC) 917 and a Base Transceiver Station (BTS) 920, 921, or a Radio Network Controller (RNC) 918 and a Node B 922. Alternatively, the categories are routed to the handheld communication devices 908-912 via a Serving GPRS Support Node (SGSN) 926, 928 to the BSC 917 and the BTS 920, 921, or the RNC 918 and the Node B 922, respectively. The BTS 920, 921 or the Node B 922 establish the air connection to the handheld communication devices 908-912.

According to an embodiment, a network operator or other third party company, for example the provider of the application, handling a category server 924 could offer a category service function where dictionaries associated with certain applications can be purchased. For example a network operator may have a dictionary server 924 supporting a feature where the user may send a category request from his handheld communication devices 908-912 to the category server 924 upon using a certain application of the handheld communication devices, e.g. a gaming or messaging application.

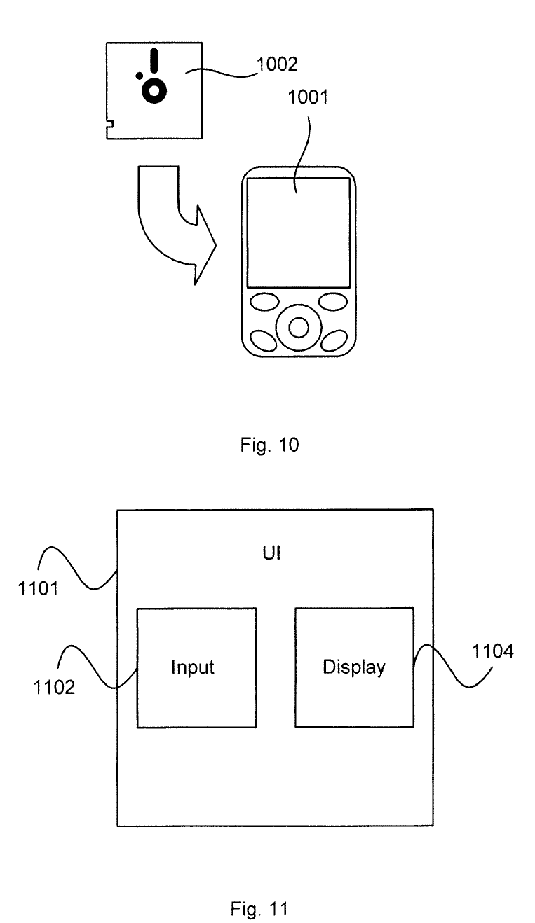

The invention can be computer-implemented, i.e. the media handling is performed on a general or dedicated computerized apparatus 1001, such as a personal computer, a mobile phone, a digital camera, a personal digital assistant, a media player, or other similar apparatus. Instructions for performing the invention can then be executed by the apparatus. These instructions can be loaded into the apparatus 1001 from a computer-readable medium 1002, as exemplary illustrated in FIG. 10, having a data structure stored. The data structure comprises the control instructions, which upon execution causes the apparatus to perform any of the disclosed embodiments as described above.

FIG. 11 illustrates a user interface (UI) 1101 in a portable apparatus having an input interface 1102, which as described in above embodiments can be actuated by a user, and a display interface 1104 for displaying information to the user as described in the above embodiments.

While the embodiments have been described with specificity to handheld communication devices, other types of computing devices with which the embodiments can be used will occur to those skilled in the art. For example, a personal computer can benefit from the invention in the same manner as the handheld communication device. Further, while the illustrated embodiments discusses the use of user-configurability, the user-configurability may be implicit or provided in some other manner than described above. The above-described embodiments of the invention are intended to be examples of the invention and alterations and modification may be affected thereto, by those skilled in the art, without departing from the scope of the invention, which is defined solely by the claims appended hereto.

1. A method for a portable apparatus, comprising:
enabling said portable apparatus for text input, comparing inputted text with text in an user configured predictive text dictionary; prioritizing matches in said comparison and listing said matches based on said prioritizing in a priority list; displaying of said priority list; enabling selection from said displayed priority list; and enabling updating of said user configured predictive text dictionary based on matches in said comparison.

2. The method according to claim 1, wherein said updating of said user configured predictive text dictionary based on any of the group: analysis of said inputted text, selected words in said displayed priority list, and user configured preferences.

3. The method according to claim 2, wherein said user configured preferences comprise of a set of words belonging to a category.

4. The method according to claim 1, communicating by wire or wirelessly with an external server via a network for acquiring said dictionary.

5. The method according to claim 4, storing said dictionaries via said network and retrieving said dictionaries from said external server.

6. A rendering application for a portable apparatus comprising a display and navigation means, said application arranged to cause enabling of said portable apparatus for text input, comparing inputted text with text in an user configured predictive text dictionary; prioritizing matches in said comparison and listing said matches based on said prioritizing in a priority list; displaying of said priority list; enabling selection from said displayed priority list; and enabling updating of said user configured predictive text dictionary based on matches in said comparison.

7. The application according to claim 6, arranged for updating said user configured predictive text dictionaries based on any of the group: analysis of said inputted text, analysis of said selected text in said priority list, and user configured preferences.

8. The application according to claim 6, arranged for communicating by wire or wirelessly with an external server via a network for acquiring said dictionary.

9. The application according to claim 8, arranged for storing said dictionaries via said network and retrieving said dictionaries from said external server.

10. An apparatus comprising a display and a comparator arranged to receive a user input, wherein said user input comprise of a text input, compare inputted text with text in a user configured predictive text dictionary, a processor arranged to prioritize and list matches of an output of said comparator in a priority list, wherein said display is arranged to, under control of said processor to display said priority list, and wherein said user input selection from said displayed priority list, wherein said processor is arranged to update said user configured predictive text dictionary based matches in said comparison.

11. The apparatus according to claim 10, further comprising a renderer for updating said user configured predictive text dictionaries based on any of the group: analysis of said inputted text, analysis of said selected text in said priority list, and user configured preferences.

12. The apparatus according to claim 10, further comprising a renderer for communicating by wire or wirelessly with an external server via a network for acquiring said dictionary.

13. The apparatus according to claim 12, further comprising a renderer for storing said dictionaries via said network and retrieving said dictionaries from said external server.

14. A computer-readable medium having computer-executable components comprising instructions for enabling said portable apparatus for text input, comparing inputted text with text in an user configured predictive text dictionary; prioritizing matches in said comparison and listing said matches based on said prioritizing in a priority list; displaying of said priority list; enabling selection from said displayed priority list; and enabling updating of said user configured predictive text dictionary based on matches in said comparison.

15. The computer-readable medium according to claim 14, further comprising instructions for updating said user configured predictive text dictionaries based on any of the group: analysis of said inputted text, analysis of said selected text in said priority list, and user configured preferences.

16. The computer-readable medium according to claim 14, further comprising instructions for communicating by wire or wirelessly with an external server via a network for acquiring said dictionary.

17. The computer-readable medium according to claim 16, further comprising instructions for storing said dictionaries via said network and retrieving said dictionaries from said external server.

18. A system comprising an apparatus and a dictionary server wherein said apparatus comprises a memory storing a set of instructions, and a processor, executing the stored set of instructions, to perform a method comprising determining an application to be executed;
determining a dictionary associated to said determined application; and enabling said associated dictionary, and
said dictionary server is arranged to provide the associated dictionary for downloading.

19. The system according to claim 18, further comprising a communications network, wherein the dictionary server and the apparatus is in communication via the communications network.

20. A user interface comprising a display, and an input receiver, wherein said user interface is arranged to; enable said portable apparatus for text input where said inputted characters are compared with words in an user configured predictive text dictionary and matches of said comparison are listed in a list; display said list in said display.
